(19) United States
(12) Patent Application Publication
(10) Pub. No.: US 2006/0120436 A1
(43) Pub. Date: Jun. 8, 2006

(54) Wireless communication system for determining the number of operation stages of interference canceller

(75) Inventor: Masahiro Komatsu, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/291,980

(22) Filed: Dec. 2, 2005

(30) Foreign Application Priority Data
Dec. 3, 2004 (JP) 2004-351344

(51) Int. Cl. H04B 1/707

(52) U.S. Cl. 375/144

(57) ABSTRACT

An SIR measurement sections are provided for respective stages of an interference canceller section and SIR values of the respective stages of the interference canceller section is notified to a station of the other end of a communication link to allow the station to determine the number of operation stages of the interference canceller section. The determined number of operation stages is received from the station and the interference canceller section is operated by the determined number of operation stages. This reduces processing time and power consumption. Further, the reduction in processing time makes it possible to perform communication according to an adaptive transmission method in an error-free manner.

### BACKGROUND OF THE INVENTION

1. Field of the Invention

The present invention relates to a wireless base station apparatus, wireless transceiver and wireless communication system and particularly, to an adaptive control method that selects an optimum modulation method and the like for a wireless communication apparatus required in a mobile communication system, a local wireless communication system, or a wireless LAN system.

2. Description of the Related Art

Conventionally, in a wireless system that performs a Direct Sequence/Code Division Multiple Access (DS/CDMA) communication using a spread spectrum signal, a plurality of signals use a single frequency band at the same time. Therefore, interference between the signals occurs depending on correlation between codes that are allocated by multipath signal or other users' signals. As a result, signal characteristics are deteriorated as the number of signals is increased. To suppress the deterioration of signal characteristics, an interference canceller has an important role.

An adaptive modulation method has been proposed so as to increase transmission capacity. The adaptive modulation method selects a modulation method, coding rate, spread rate, code number, use frequency band and coding method, depending on a state of a transmission path that varies every hour due to fading or shadowing. A technique related to this is disclosed in, for example, JP-A 2001-251242.

FIG. 1 shows an example of a conventional system. Firstly, receiving section 81 of a base station receives a signal transmitted from a mobile station and interference canceller section 82 then removes interference included in the reception signal output from the receiving section 81. Subsequently, decoding section 83 decodes the interference-removed signal output from the interference canceller section 82 to generate decoded data.

Signal-to-interference power ratio (SIR) measurement section 84 measures the SIR of the signal from which interference has been removed in the interference canceller section 82. Control signal generation section 85 then generates a control signal for notifying the SIR information measured in the SIR measurement section 84, to a receiver station at the other end of a communication link. Transmission signal generation section 86 multiplexes the control signal generated by the control signal generation section 85 and transmission data, and the resultant transmission signal is transmitted by transmitting section 87.

Receiving/demodulating section 91 of a mobile station receives and demodulates the signal transmitted from the base station and outputs the demodulate signal to decoding section 92. The decoding section 92 then decodes the demodulate signal. Control signal acquisition section 93 acquires a control signal output from the receiving/demodulating section 91. Transmission method control section 94 then determines a modulation method, coding rate, spread rate, code number, use frequency band and coding method based on the SIR information included in the control signal acquired by the control signal acquisition section 93. Transmission signal creation section 95 creates a transmission signal according to the modulation method, coding rate, spread rate, code number, use frequency band and coding method determined by the transmission method control section 94 and the resultant transmission signal is transmitted by transmitting section 96.

A first disadvantage of the related art is that the interference canceller has a multistage structure and thereby it takes long time if processing is performed to the last stage. That is, since data needed to be transmitted and received promptly are also processed to the last stage, it takes long time to complete transmission/reception of the data. In particular, in the case where a serial interference canceller is used, it takes 100 millisecond or more to complete transmission/reception of data, with the result that a voice communication cannot be made smoothly. Further, it also takes long time to acquire the SIR of the last stage, with the result that control of the transmission method control is delayed. Therefore, it is highly possible that a state of a transmission path varies by just that much. As a result, the control did not work well in some cases.

A second disadvantage is that an adaptive modulation function determines an optimum modulation method by which data is transmitted/received according to the SIR of the last stage, so that if a modulation method, coding rate, spread rate, code number, use frequency band and coding method that allow a large number of data to be transmitted in one frame are selected although the data amount is small, it is necessary to transmit dummy data in order to fill the frame with data, thus incurring waste. Further, a normal communication could not be made with the selected transmission method due to a variation of a state of a transmission path, in some cases.

### SUMMARY OF THE INVENTION

The present invention has been made in view of the above disadvantage relating to the prior art, and an object thereof is to provide a wireless base station apparatus, wireless transceiver and wireless communication system capable of improving the performance thereof, by which processing time can be shortened and communication errors can be reduced.

According to an aspect of the present invention, there is provided a wireless base station apparatus comprising: a receiving section that receives a spread spectrum signal; an interference canceller section that removes interference included in a reception signal output from the receiving section and measures the SIR of the signal from which interference in the respective stages has been removed; a decoding section that decodes the interference-removed signal output from the interference canceller section; a control signal generation section that generates a control signal for notifying a receiver station of the SIR information of the respective stages measured by the interference canceller section; a transmission signal generation section that multiplexes the control signal generated by the control signal generation section and transmission data; and a transmitting section that transmits the transmission signal including the control signal which is generated by the transmission signal generation section.

According to another aspect of the present invention, there is provided a wireless transceiver comprising: a receiving and demodulating section that receives and demodulates a spread spectrum signal; a decoding section that decodes the demodulate signal output from the receiving and demodulating section; a transmission method control section that determines the number of operation stages of an interference canceller in a station at the other end of a wireless link based on the SIR information of the respective stages of the interference canceller of a station at the other end of a wireless link which is included in a control signal output from the receiving and demodulating section and the type and amount of the signal to be transmitted; a transmission signal creation section that creates a transmission signal including the number of operation stages of the interference canceller which is determined by the transmission method control section; and a transmitting section that transmits the transmission signal created by the transmission signal creation section.

### BRIEF DESCRIPTION OF THE DRAWINGS

FIG. 1 is a block diagram showing an example of a conventional wireless system;

FIG. 2 is a block diagram showing a configuration of an embodiment of the present invention;

FIG. 3 is a block diagram showing an example of an interference canceller of FIG. 1;

FIG. 4 is a block diagram showing an example of an ICU section of FIG. 2;

FIG. 5 is a block diagram showing an example of a switching subtraction section (subtraction section with switching function) of FIG. 2;

FIG. 6 is a block diagram showing an example of a receiving section of FIG. 2;

FIG. 7 is a flowchart for explaining a procedure of determining the number of operation stages of the interfere canceller section and transmission method in the transmission method control section of FIG. 1;

FIG. 8 is a view showing an example of SIR values of the respective stages of the interference canceller section and required SIR values corresponding to respective transmission methods;

FIG. 9 is a block diagram showing mobile station as a computer configuration; and

FIG. 10 is a block diagram showing base station as a computer configuration.

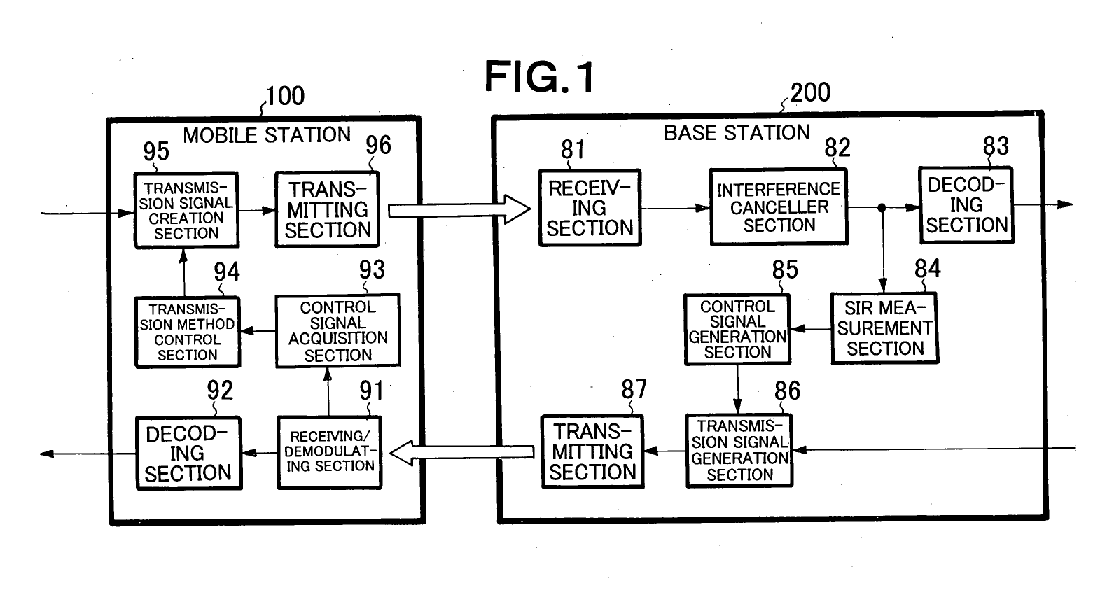

### DETAILED DESCRIPTION OF THE PREFERRED EMBODIMENTS

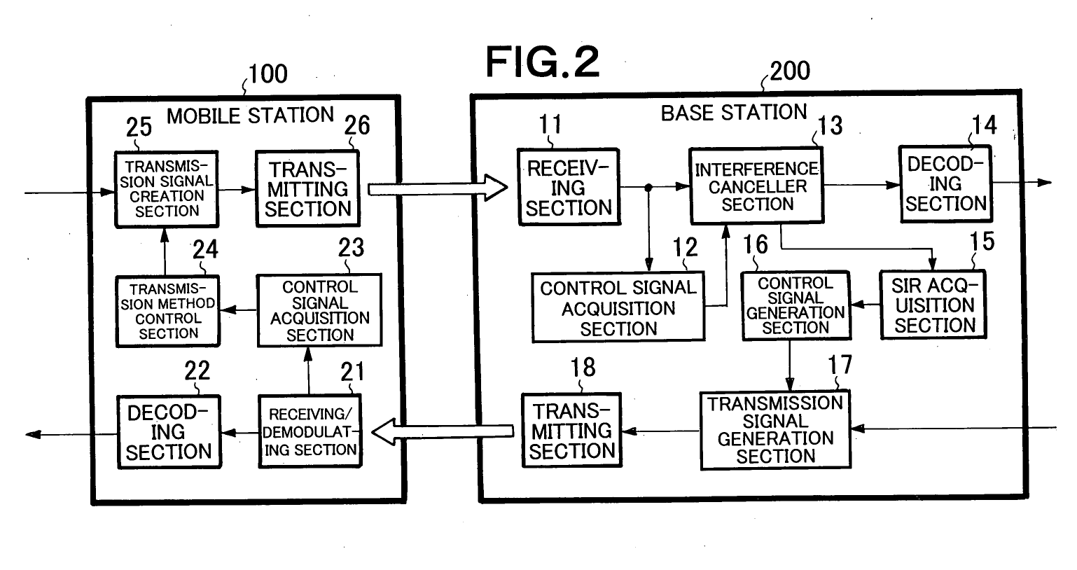

An embodiment of the present invention will be described in detail below with reference to the accompanying drawings. FIG. 2 is a block diagram showing a configuration of the embodiment of a wireless communication system according to the present invention. The wireless communication system has mobile station 100 for each user and base station 200 capable of communicating with the plurality of mobile stations through a wireless network.

Firstly, receiving section 11 of the base station 200 receives a spread spectrum signal transmitted from the mobile station 100. Then, a control signal acquisition section 12 acquires a control signal including designation of the number of operation stages of an interference canceller, modulation method, coding rate, spread rate, code number, use frequency band and coding method from the reception signal output from the receiving section 11.

Interference canceller section 13 removes interference included in the reception signal output from the receiving section 11 and measures the SIR of the signal from which interference in the respective stages has been removed. The number of stages of the interference canceller that removes interference follows the designation of the number of operation stages of an interference canceller, which is included in the control signal acquired by the control signal acquisition section 12.

Decoding section 14 decodes the signal output from the interference canceller section 13, from which interference in the respective stages has been removed, to thereby generate decoded data.

SIR acquisition section 15 acquires the SIR of the signal from which interference in the respective stages has been removed in the interference canceller section 13. Control signal generation section 16 then generates a control signal for notifying the SIR information of the respective stages of the interference canceller section acquired by the SIR acquisition section 15, to a receiver station at the other end of a communication link. Transmission signal generation section 17 multiplexes the control signal generated by the control signal generation section 16 and transmission data, and the resultant transmission signal is transmitted by transmitting section 18.

Receiving/demodulating section 21 of the mobile station 100 receives and demodulates the spread spectrum signal transmitted from the base station 200 and outputs the demodulate signal to a decoding section 22. The decoding section 22 then decodes the demodulate signal.

Control signal acquisition section 23 acquires a control signal including the SIR information of the respective stages of the interference canceller section 13, which has been output from the receiving/demodulating section 21.

Transmission method control section 24 then determines the number of operation stages of the interference canceller section 13 of the base station 200, modulation method, coding rate, spread rate, code number, use frequency band and coding method based on the SIR information of the respective stages of the interference canceller section 13 included in the control signal acquired by the control signal acquisition section 23 and the type or amount of a signal to be transmitted. Transmission method control section 24 may determine at least one of the number of operation stages of the interference canceller section 13 of the base station 200, modulation method, coding rate, spread rate, code number, use frequency band and coding method.

A transmission signal creation section 25 creates a transmission signal according to the modulation method, coding rate, spread rate, code number, use frequency band, and coding method determined by the transmission method control section 24. A transmitting section 26 then transmits the transmission signal created by the transmission signal creation section 25 together with the control signal including the information of the number of operation stages of the interference canceller section 13, modulation-method, coding rate, spread rate, code number, use frequency band, and coding method.

Details of the configuration of the base station 200 will next be described. Firstly, the receiving section 11 of the base station 200 receives a signal transmitted from the mobile station 100.

The control signal acquisition section 12 then acquires a control signal including designation of the number of operation stages of the interference canceller, modulation method, coding rate, spread rate, code number, use frequency band, and coding method from the reception signal output from the receiving section 11. The control signal is transmitted over a channel different from the channel used for a data signal, or is time-multiplexed into the data signal.

The interference canceller section 13 removes interference included in the reception signal output from the receiving section 11 and measures the SIR of the signal from which interference in the respective stages has been removed.

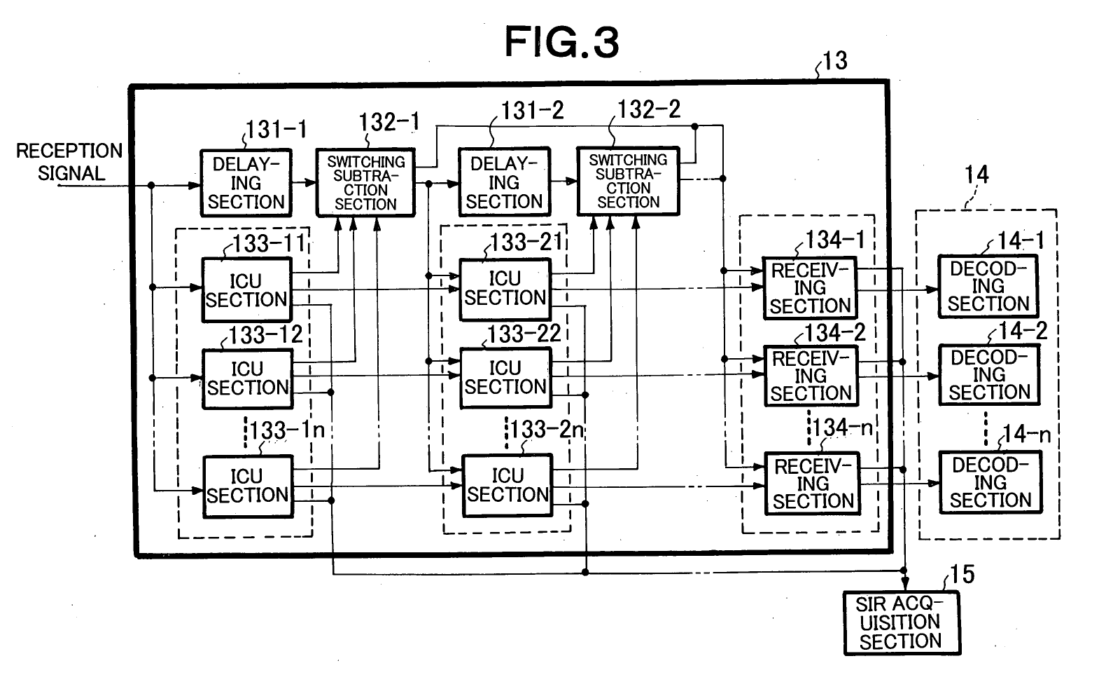

FIG. 3 is a block diagram showing an example of a parallel interference canceller including a plurality of stages, which performs processing for each user. In FIG. 3, the reception signal from the receiving section 11 is input to interference cancellation unit (ICU) sections 133-11 to 133-1n (“n” indicates the number of ICU sections). Each of the ICU sections 133-1 to 133-1n is provided for each user, where creation of an interference replica and measurement of the SIR are performed. The interference replica is output to ICU sections 133-21 to 133-2n (“n” indicates the number of ICU sections) of the next stage and switching subtraction section (subtraction section with switching function) 132-1. A measurement result of the SIR is output to the SIR acquisition section 15.

The reception signal from the receiving section 11 is transmitted also to delaying section 131-1, which delays the reception signal by the time corresponding to the processing time of each of the ICU sections 133-11 to 133-1n. The switching subtraction section 132-1 deletes the interference replica from the reception signal. Delaying section 131-2, ICU sections 133-21 to 133-2n (“n” indicates the number of ICU sections) and switching subtraction section 132-2 (second stage) have same functions as the functions of the Delaying section 131-1, the ICU sections 133-11 to 133-1n and the switching subtraction section 132-1. The stage subsequent to the second stage has same functions as the functions of the second stage.

Receiving sections 134-1 to 134-n (“n” indicates the number of ICU sections) of the last stage of the interference canceller section 13 receive the interference replicas from ICU sections (last stage ICU sections) of the previous stage, and the interference-removed signals from the switching subtraction section 132-1 to last stage switching subtraction section as inputs and demodulates them. The demodulated signals are output to the decoding section 14. The decoding section 14 contains a plurality of decoding portions 14-1 to 14-n (“n” indicates the number of ICU sections).

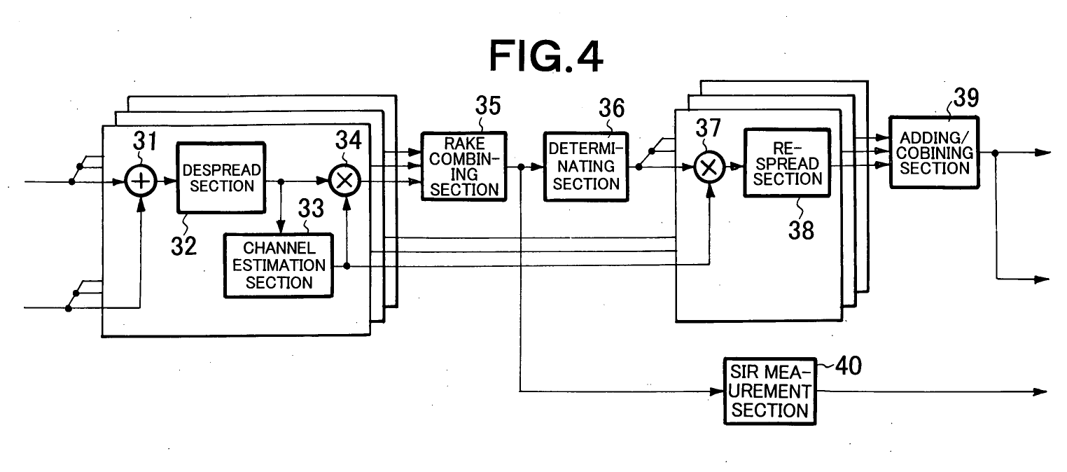

FIG. 4 is a block diagram showing an example of an ICU section for one user. The ICU section of FIG. 4 corresponds to each of the ICU sections 133-11 to 133-1n and 133-21 to 133-2n, or the ICU sections subsequent to ICU sections 133-21 to 133-2n.

As shown in FIG. 4, the ICU section includes adding section 31, despread section 32, channel estimation section 33, multiplying section 34, RAKE combining section 35, determinating section 36, multiplying section 37, respread section 38, adding and combining section 39, and SIR measurement section 40.

The ICU section performs processing based on a modulation method, coding rate, spread rate, code number, use frequency band, and coding method designated in the control signal.

A first stage of the ICU section (that is, each of the ICU sections 133-11 to 133-1n) receives a reception signal from the receiving section 11. A second (that is, each of the ICU sections 133-21 to 133-2n), third, . . . , and last ICU section receives the signal from which interference has been removed in the switching subtraction section and the interference replica from the ICU section of the previous stage and allows the adding section 31 to perform addition with the interference-removed signal and the interference replica set as inputs. The dispreading section 32 then despreads the signal from the adding section 31 to generate symbol-rate data. A despread method that uses a matched filter to despread chip data using despread codes is available.

The channel estimation section 33 uses pilot symbols that have been despread and output from the despread section 32 to perform channel estimation. The multiplying section 34 multiplies data symbols from the despread section 32 and the complex conjugate value of the channel estimation value calculated by the channel estimation section 33. Each of the processing from the adding section 31 to multiplying section 34 is performed for each path. The reason is to cope with a plurality of delayed waves. Although FIG. 4 shows a case of three paths, the number of paths may be one or more.

The RAKE combining section 35 performs RAKE combining by carrying out maximum ratio combining based on the output data from the multiplying section 34 for each path. A method that uses an equalizer to equalize a signal is available as the method other than the method that despreads a reception signal and performs RAKE combining. The RAKE combining signal from the RAKE combining section 35 is output to the determinating section 36 and SIR measurement section 40.

The determinating section 36 tentatively determines the signal that has been subjected to maximum ratio combining by the RAKE combining section 35. The multiplying section 37 multiplies the signal that has been tentatively determined by the determinating section 36 by the channel estimation value from the channel estimation section 33 to create a symbol replica. The respread section 38 applies respread processing to the symbol replica from the multiplying section 37. This processing is performed for each path. The adding and combining section 39 adds and combines the signal of each path from the respread section 38 to create an interference replica. Although the determination has been made after the RAKE combining in the example of FIG. 4, a method in which a forward error correction (FEC) is performed after the RAKE combining and the determination is made after the FEC is available.

The SIR measurement section 40 uses the RAKE combining signal from the RAKE combining section 35 to calculate the SIR. A received power (which is obtained by squaring the average of the RAKE combining signal) is divided by an interference power (which is obtained by squaring the standard deviation of the RAKE combining signal) to thereby obtain the SIR. Another method of using the interference-removed signal from the switching subtraction section 132 is also available for the calculation of the interference power.

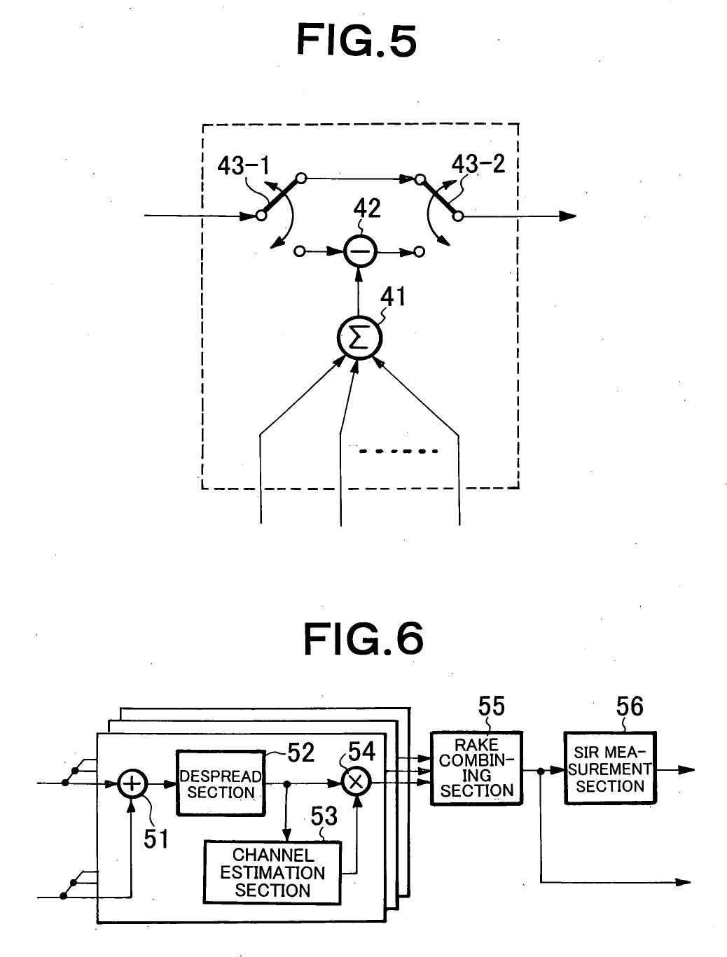

FIG. 5 is a block diagram showing in detail the configuration of a switching subtraction section for one user. The switching subtraction section of FIG. 5 corresponds to the switching subtraction section 132-1 or 132-2, or the switching subtraction section subsequent to the switching subtraction section 132-2.

As shown in FIG. 5, the switching subtraction section includes adding section 41, subtractor section 42, and switches 43-1 and 43-2.

The switch 43 allows a signal from the delaying section 131 to pass therethrough or delete an interference replica included in the signal so as not to allow interference canceller sections the numbers of operation stages of which are larger than a predetermined number of operation stages to operate. The adding section 41 adds and combines interference replicas of all users. The subtracting section 42 subtracts the interference replicas of all users from the signal input from the delaying section 131-1 or 131-2.

FIG. 6 is a block diagram showing in detail the configuration of a receiving section for one user. The receiving section of FIG. 6 corresponds to each of the receiving sections 134-1 to 134-n.

As shown in FIG. 6, the receiving section includes adding section 51, despread section 52, channel estimation section 53, multiplying section 54, RAKE combining section 55, and SIR measurement section 56.

The receiving section performs processing based on the modulation method, coding rate, spread rate, code number, use frequency band, and coding method in a control signal.

The receiving section receives the signals from which interference have been removed by the switching subtraction section 132-1 to last stage switching subtraction section and the interference replica from the ICU section (one of last stage ICU sections) of the previous stage as inputs and allows the adding section 51 to add them. The despread section 52 despreads the signal from the adder section 51 to generate symbol rate data. The channel estimation section 53 uses pilot symbols that have been despread and output from the despread section 52 to perform channel estimation.

The multiplying section 54 multiplies data symbols from the despread section 52 and the complex conjugate value of the channel estimation value calculated by the channel estimation section 53. Each of the processing from the adding section 51 to multiplying section 54 is performed for each path. The RAKE combining section 55 performs RAKE combining by carrying out maximum ratio combining based on the output data of each path from the multiplying section 54. The SIR measurement section 56 uses the RAKE combining signal from the RAKE combining section 55 to calculate the SIR.

Although the interference canceller that removes interference for each user is shown in FIG. 3, it may be possible to use an interference canceller that removes a multipath signal or other signals. Further, although the parallel interface canceller is used in the example of FIG. 3, it may be possible to use a serial interference canceller in the same manner by measuring the SIR values in the respective stages.

The decoding section 14 decodes the signal output from the interference canceller section 13 to create decoded data.

The SIR acquisition section 15 acquires the SIR of the signal from which interference in the respective stages has been removed in the interference canceller section 13. The control signal generation section 16 then generates a control signal for notifying the SIR information of the respective stages acquired by the SIR acquisition section 15, to a receiver station at the other end of a communication link. For example, the control signal uses 8-bit/Q3 format to represent the SIR of one stage and uses 32-bit to represent four stages. The transmission signal generation section 17 multiplexes the control signal generated by the control signal generation section 16 and transmission data. Examples of the multiplication method include time multiplication, frequency multiplication, and code multiplication. The transmission signal generated by the transmission signal generation section 17 is transmitted by the transmitting section 18.

Details of the mobile station 100 will next be described. The receiving/demodulating section 21 of the mobile station 100 receives and demodulates the signal transmitted from the base station 200 and outputs the demodulate signal to the decoding section 22. The decoding section 22 then decodes the demodulate signal.

The control signal acquisition section 23 acquires a control signal including the SIR information of the respective stages of the interference canceller section 13 of the base station 200, which has been output from the receiving/demodulating section 21. The transmission method control section 24 then determines the number of operation stages of the interference canceller section 13 of the base station 200, modulation method, coding rate, spread rate, code number, use frequency band and coding method. They are determine on the basis of the SIR information of the respective stages of the interference canceller section 13 included in the control signal acquired by the control signal acquisition section 23, and the type or amount of a signal to be transmitted. Notification of the maximum number of operation stages of the interference canceller of the base station 200 is previously made to the mobile station 100 at the communication start time.

Examples of the modulation method include Quadrature Phase Shift Keying (QPSK), 16 Quadrature AM (QAM), 64 QAM, 8 Phase Shift Keying (PSK). Example of the coding rate include 1/3 and 1/2. Examples of the spread rate include 1, 2, 4, 8, and 16. Examples of the code number include positive integer less than the spread rate. Examples of the use frequency band include 1 and 2. Examples of the coding method include convolution and turbo coding. The receiver station at the other end of a communication link can receive the value of the SIR in an error-free manner according to a transmission method obtained by combining the above specifications. The value of the SIR can be acquired by previous measurement or by appropriate acquisition and update of error information of the station at the other end of a communication link. Further, the number of data bits that can be transmitted in one frame can uniformly be determined depending on the set transmission method.

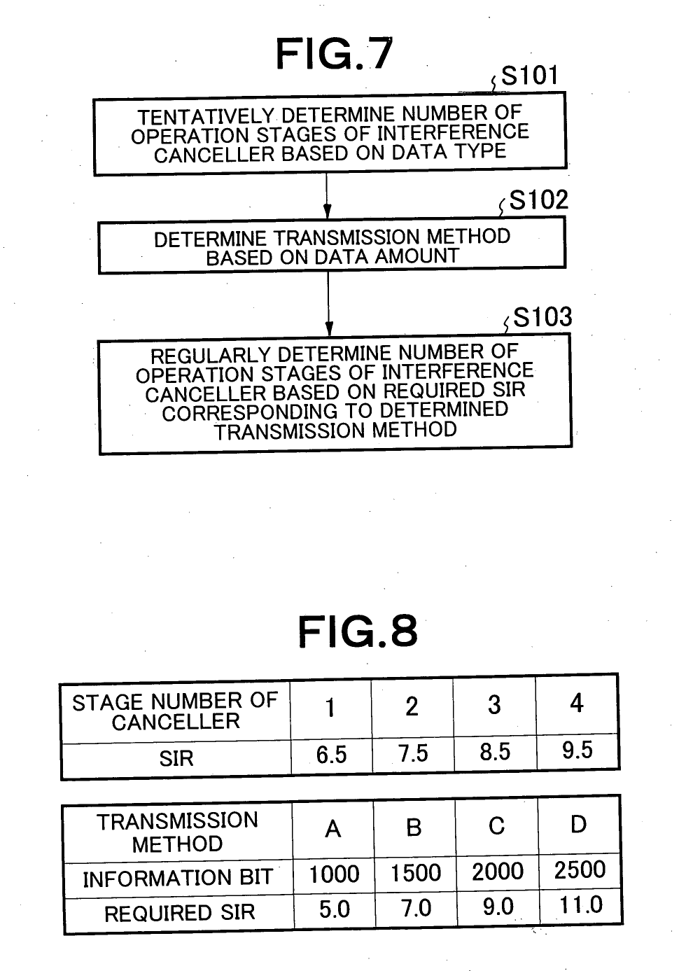

FIG. 7 shows a procedure of determining the number of operation stages of the interfere canceller section in the base station 200, modulation method, coding rate, spread rate, code number, use frequency band and coding method. They are determined on the basis of the SIR information of the respective stages of the interference canceller section of the base station 200 included in the acquired control signal, and the type or amount of the signal to be transmitted. Here, not a case of a transmission of voice data for which a delay needs to be reduced as much as possible since the voice data are exchanged interactively, but a case of a transmission of an e-mail message data having a bit length of 1400 for which a slight delay is acceptable is taken as an example.

FIG. 8 shows an example of SIR values of the respective stages of the interference canceller section, which have been transmitted from the base station 200 having an interference canceller of four stages and required SIR values corresponding to respective transmission methods.

Firstly, the number of operation stages of the interference canceller section is tentatively determined based on the data type (step 101 of FIG. 7). In this case, the number of operation stages of the interference canceller section is made small for the data transmission for which a delay needs to be reduced; whereas the number of operation stages is made large for the data transmission for which a slight delay is acceptable. Since a delay can be ignored in this example, the number of operation stages of the interference canceller section is tentatively set to four.

Next, transmission methods are selected from among the transmission methods that satisfy the SIR corresponding to the tentatively set number of operation stages of the interference canceller section, on the basis of the amount of data to be transmitted (step 102). In the case where there are a plurality of transmission methods that can transmit the number of information bits larger than the amount of the data to be transmitted among the transmission methods that satisfy the SIR corresponding to the tentatively set number of operation stages of the interference canceller section, a transmission method whose transmittable number of information bits is larger than and closest to the amount of the data to be transmitted is selected.

If there is no transmission method that can transmit the number of information bits larger than the amount of the data to be transmitted among the transmission methods that satisfy the SIR corresponding to the tentatively set number of operation stages of the interference canceller section, a transmission method whose transmittable number of information bits is largest among the transmission methods that satisfy the SIR corresponding to the tentatively set number of operation stages of the interference canceller section is selected. As shown in FIG. 8, in this example, the transmission methods that satisfy SIR=9.5 corresponding to the tentatively set number of operation stages of the interference canceller section are A, B, and C. Among these, the transmission method B whose transmittable number of information bits is larger than and closest to 1400 is selected because the data amount is 1400.

Finally, the minimum number of operation stages is selected from among the numbers of operation stages of the interference canceller section that satisfy required SIR corresponding to the selected transmission method to thereby regularly determine the number of operation stages of the interference canceller section (step 103). The required SIR corresponding to the transmission method B is 7.0, so that the number of operation stages of the interference canceller section is determined to be 2 in which the SIR is larger than 7.0.

In practice, the SIR values of the respective stages vary, so that it is possible to use a value obtained by subtracting a constant number from the SIR value. Further, it takes time to complete the processing of the interference canceller. That is, although the SIR of the first stage is promptly acquired, acquisition of the SIR of the subsequent stage is delayed to allow the SIR of the current stage to vary. Therefore, the constant number may be changed depending on the stage number (the larger the stage number, the larger the constant number is made). Further, it may be possible to estimate the current SIR of a given stage based on the temporal change in the SIR values of the respective stages of the interference canceller to be notified. In addition, it may be possible to adopt number of operation stages of the interference canceller that has been tentatively determined at the beginning without regular determination to be made at the last.

In the example of FIG. 7, firstly, the number of operation stages of the interference canceller is tentatively determined based on the data type, a transmission method is then determined based on the data amount, and finally the number of operation stages of the interference canceller is regularly determined based on the required SIR corresponding to the determined transmission method. Alternatively, however, another procedure may be adopted, in which firstly a transmission method is tentatively determined based on the data amount, the number of operation stages of the interference canceller is then tentatively determined based on the data type, and finally the transmission method is regularly determined based on the SIR of the determined number of operation stages of the interference canceller.

In this case, firstly a transmission method is tentatively determined based on the amount of the data to be transmitted. More specifically, a transmission method whose transmittable number of information bits is closest to the amount of the data to be transmitted is selected among the transmission methods that can transmit the number of information bits larger than the amount of the data to be transmitted to tentatively determine a transmission method. Then, the number of operation stages of the interference canceller is determined based on the data type. Concretely speaking, the number of operation stages of the interference canceller is made small for transmission of data for which a delay needs to be reduced as much as possible; whereas the number of operation stages of the interference canceller is made large for transmission of data for which a slight delay is acceptable.

Finally, a transmission method is regularly determined based on the SIR corresponding to the determined number of operation stages of the interference canceller. In the case where the SIR corresponding to the determined number of operation stages of the interference canceller does not satisfy the required SIR corresponding to the tentatively determined transmission method, a transmission method whose required SIR is smaller than and closest to the SIR corresponding to the determined number of operation stages of the interference canceller is selected.

The transmission signal creation section 25 creates a transmission signal according to the modulation method, coding rate, spread rate, code number, use frequency band, and coding method determined by the transmission method control section 24. The transmitting section 26 transmits the transmission signal created by the transmission signal creation section 25 together with a control signal including information related to the number of operation stages of the interference canceller section, modulation method, coding rate, spread rate, code number, use frequency band, and coding method.

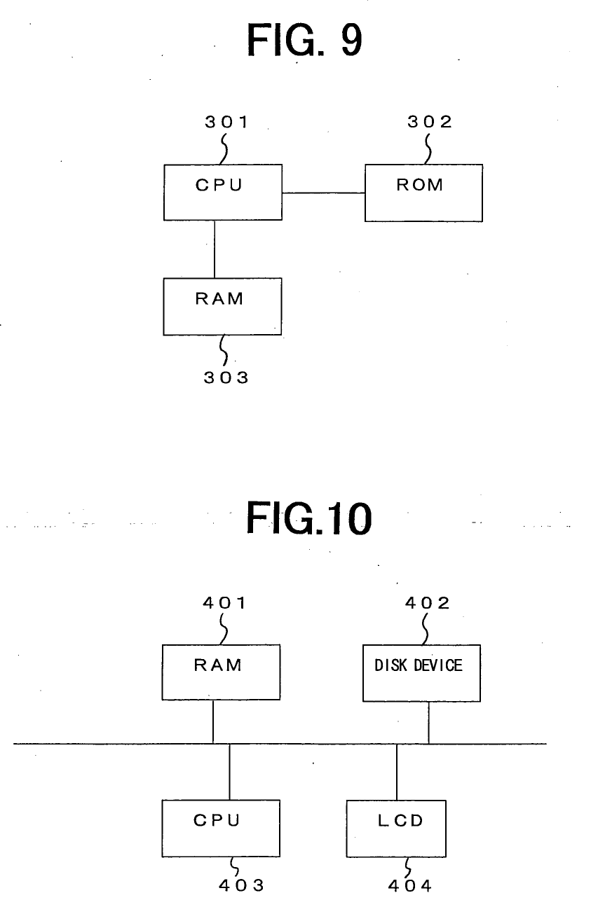

The mobile station 100 and base station 200 of FIG. 2 can be constructed by a hard ware, for example, by using dedicated (exclusive use) ICs. However, the functions of the mobile station 100 and base station 200 may be carried out by a soft ware. In this case, the mobile station 100 can use a computer configuration as shown in FIG. 9 and the base station 200 can use a computer configuration as shown in FIG. 10.

As shown in FIG. 9, the mobile station 100 includes CPU 301, ROM 302 (storage portion) that stores a control program of the CPU 301 and RAM (storage portion) 303 that is used for carrying out data processing of the CPU 301. The control program carries out the function of each section of the mobile station 100.

As shown in FIG. 10, the base station 200 includes CPU 403, disk device 402 (storage portion) that stores a control program of the CPU 403 and RAM (storage portion) 401 that is used for carrying out data processing of the CPU 403. The control program carries out the function of each section of the base station 200.

A first advantage of the present embodiment is that the number of stages to be subjected to interference removal is specified to perform the interference removal for only the required number of stages and thereby it is possible to reduce processing time and power consumption. Further, the reduction in processing time reduces a control delay, making it possible to perform communication according to an adaptive transmission method in a more error-free manner.

A second advantage of the present embodiment is that it is possible to reduce dummy data to the minimum necessary by determining the modulation method, coding rate, spread rate, code number, use frequency band, or coding method based not only on the type and amount of the data to be transmitted but also on the SIR information of a station of the other end of a communication link. Further, a transmission method that can transmit data in a more reliable manner is selected, so that it is possible to reduce a transmission error.

1. A wireless base station apparatus comprising:
a receiving section which receives a spread spectrum signal;
an interference canceller section which removes interference included in a reception signal output from said receiving section and measures SIR of the signal from which interference in the respective stages has been removed;
a decoding section which decodes the interference-removed signal output from said interference canceller section;
a control signal generation section which generates a control signal for notifying a receiver station of the SIR information of the respective stages measured by said interference canceller section;
a transmission signal generation section which multiplexes the control signal generated by said control signal generation section and transmission data; and
a transmitting section which transmits the transmission signal including the control signal which is generated by said transmission signal generation section.

2. The wireless base station apparatus according to claim 1, wherein
said interference canceller section includes at least one stage of an ICU section and subtraction section, said ICU section dispreading the reception signal, multiplying a channel estimation value to measure the SIR and performing respread after determining the signal multiplied by the channel estimation value to generate an interference replica, and said subtraction section subtracting the interference replica from the reception signal.

3. The wireless base station apparatus according to claim 1, wherein
said interference canceller section performs interference removal by the number of stages specified by control information including the reception signal.

4. A wireless transceiver comprising:
a receiving and demodulating section which receives and demodulates a spread spectrum signal;
a decoding section which decodes the demodulate signal output from said receiving and demodulating section;
a transmission method control section which determines the number of operation stages of an interference canceller in a station at the other end of a wireless link based on the SIR information of the respective stages of the interference canceller and the type and amount of the signal to be transmitted, said SIR information being included in a control signal output from said receiving and demodulating section;
a transmission signal creation section which creates a transmission signal including the number of the operation stages which is determined by said transmission method control section; and
a transmitting section which transmits a transmission signal created by said transmission signal creation section.

5. The wireless transceiver according to claim 4, wherein
said transmission method control section determines at least one of a modulation method, coding rate, spread rate, code number, use frequency band and coding method used in the station, on the basis of the SIR information and the type and amount of data to be transmitted.

6. A wireless communication system comprising:
a wireless base station apparatus comprising a receiving section which receives a spread spectrum signal;
an interference canceller section which removes interference included in a reception signal output from said receiving section and measures SIR of the signal from which interference in the respective stages has been removed;
a decoding section which decodes the interference-removed signal output from said interference canceller section;
a control signal generation section which generates a control signal for notifying a receiver station of the SIR information of the respective stages measured by said interference canceller section;
a transmission signal generation section which multiplexes the control signal generated by said control signal generation section and transmission data; and
a transmitting section which transmits the transmission signal including the control signal which is generated by said transmission signal generation section; and also comprising
a wireless transceiver according to claim 4, wherein
said base station apparatus transmits the SIR information of respective stages measured by said interference canceller section, and
said wireless transceiver transmits the number of operation stages of said interference canceller section based on the SIR information and the type and amount of the signal to be transmitted.

7. A wireless communication method for a wireless base station apparatus, said method comprising:
a first step of receiving a spread spectrum signal;
at least one second step of removing interference included in the signal received in said first step and measuring SIR of the signal from which the interference has been removed;
a third step of decoding the signal interference-removed in said at least one second step;
a fourth step of generating a control signal for notifying a receiver station of the SIR information measured every said second step;
a fifth step of multiplexing the control signal generated in said fourth step and transmission data; and
a sixth step of transmitting a signal which is generated in fifth step.

8. A wireless communication method for a wireless transceiver, said method comprising:
a first step of receiving and demodulating a spread spectrum signal;
a second step of decoding the signal received and demodulated in said first step;
a third step of determining the number of operation stages of an interference canceller in a station at the other end of a wireless link based on the SIR information of the respective stages of the interference canceller and the type and amount of the signal to be transmitted, said SIR information being included in a control signal demodulated in said second step;
a fourth step creating a transmission signal including the number of the operation stages which is determined in said third step; and
a fifth step transmitting a transmission signal created in said by said fourth step.

9. A program product embodied on a storage portion of a computer and comprising codes which, when said program product is executed, causes said computer to perform a method comprising:
a first step of receiving a spread spectrum signal;
at least one second step of removing interference included in the signal received in said first step and measuring SIR of the signal from which the interference has been removed;
a third step of decoding the signal interference-removed in said at least one second step;
a fourth step of generating a control signal for notifying a receiver station of the SIR information measured every said second step;
a fifth step of multiplexing the control signal generated in said fourth step and transmission data; and
a sixth step of transmitting a signal which is generated in fifth step.

10. A program product embodied on a storage portion of a computer and comprising codes which, when said program product is executed, causes said computer to perform a method comprising:
a first step of receiving and demodulating a spread spectrum signal;
a second step of decoding the signal received and demodulated in said first step;
a third step of determining the number of operation stages of an interference canceller in a station at the other end of a wireless link based on the SIR information of the respective stages of the interference canceller and the type and amount of the signal to be transmitted, said SIR information being included in a control signal demodulated in said second step;
a fourth step creating a transmission signal including the number of the operation stages which is determined in said third step; and
a fifth step transmitting a transmission signal created in said fourth step.
